(19) United States
(12) Patent Application Publication
(10) Pub. No.: US 2012/0141913 A1
(43) Pub. Date: Jun. 7, 2012

(54) POLYMER ELECTROLYTE MEMBRANE FOR POLYMER ELECTROLYTE FUEL CELL, METHOD OF MANUFACTURING THE SAME AND POLYMER ELECTROLYTE FUEL CELL SYSTEM INCLUDING THE SAME

(75) Inventors: Young Moo Lee, Seoul (KR); Chi Hoon Park, Seoul (KR); Doo Sung Hwang, Seoul (KR)

(73) Assignee: IUCF-HYU (Industry-University Cooperation Foundati on Hanyang University, seoul (KR)

(21) Appl. No.: 13/141,804

(22) PCT Filed: Aug. 19, 2010
(86) PCT No.: PCT/KR2010/005508

§ 371 Date: Jun. 23, 2011

(30) Foreign Application Priority Data
Aug. 21, 2009 (KR) 10-2009-0077748
Aug. 17, 2010 (KR) 10-2010-0079257

(51) Int. Cl. H01M 8/10; C08J 5/20

(52) U.S. Cl. 429/492; 429/535; 521/27

(57) ABSTRACT

A polymer electrolyte membrane for a polymer electrolyte fuel cell, a method of manufacturing the same, and a polymer electrolyte fuel cell system including the same are disclosed, and the polymer electrolyte membrane includes a hydrocarbon-based proton conductive polymer membrane. The polymer membrane has a surface contact angle ranging from 80° to 180°.

### BACKGROUND OF THE INVENTION

(a) Field of the Invention

This disclosure relates to a polymer electrolyte membrane for a polymer electrolyte fuel cell, a method of manufacturing the same, and a polymer electrolyte fuel cell system including the same.

(b) Description of the Related Art

A fuel cell is a power generation system for producing electrical energy through the electrochemical redox reaction of an oxidant and hydrogen included in a hydrocarbon-based material such as methanol, ethanol, natural gas, and the like.

Such a fuel cell is a clean energy source that can replace fossil fuels, and it includes a stack composed of unit cells, and has an advantage of producing various ranges of power, and since it has a four to ten times higher energy density than a small lithium cell, it has been high-lighted as a small portable power source.

Typical examples of a fuel cell are a polymer electrolyte membrane fuel cell (PEMFC) and a direct oxidation fuel cell (DOFC). The direct oxidation fuel cell which uses methanol as a fuel is called a direct methanol fuel cell (DMFC).

In a fuel cell, the stack that actually generates electricity includes several to scores of unit cells stacked in multiple layers, and each unit cell is made up of a membrane-electrode assembly (MEA) and a separator (also referred to as a bipolar plate). The membrane-electrode assembly has an anode (referred to as a fuel electrode or an oxidation electrode) and a cathode (referred to as an air electrode or a reduction electrode) attached to each other with a polymer electrolyte membrane including a proton conductive polymer therebetween, through a binder having proton conductivity.

Electricity in a fuel cell is generated by supping a fuel to an anode and adsorbed in catalysts of the anode, oxidizing to produce protons and electrons, transferring the electrons into the cathode, an oxidizing electrode, via an electric condcutive external circuit, while the protons are transferred into the polymer electrolyte membrane through a proton donductive binder pass the polymer electrolyte membrane including a proton conductive polymer and then, a proton donductive binder again, and reach the cathode. In addition, an oxidant is supplied to the cathode, and then, the oxidant, protons, and electrons are reacted on catalysts of the cathode to produce electricity along with water.

### SUMMARY OF THE INVENTION

One embodiment of the present invention provides a polymer electrolyte membrane for a polymer electrolyte fuel cell, which can improve performance of the fuel cell.

Another embodiment of the present invention provides a method of manufacturing the polymer electrolyte membrane.

Yet another embodiment of the present invention provides a polymer electrolyte fuel cell system including the polymer electrolyte membrane.

According to one embodiment of the present invention, a polymer electrolyte membrane for a polymer electrolyte fuel cell includes a hydrocarbon-based proton conductive polymer membrane, and the polymer electrolyte membrane may have a surface contact angle ranging from 80° to 180°. The polymer electrolyte membrane may have a surface contact angle ranging between 80° or more, and less than 120°, and thus may be hydrophobic.

The hydrocarbon-based proton conductive polymer is a polymer having a proton conductive group. The polymer may be a hydrocarbon-based polymer selected from the group consisting of a benzimidazole-based polymer, a benzoxazole-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer, a polyphenylquinoxaline-based polymer, a copolymer thereof, and a combination thereof.

According to another embodiment of the present invention, provided is a method of preparing the polymer electrolyte membrane to have a hydrophobic surface by treating a hydrocarbon-based proton conductive polymer membrane by using plasma.

Herein, the hydrophobic treatment by using plasma may be performed by blowing in a first gas selected from the group consisting of argon gas, nitrogen gas, oxygen gas, helium gas, or a combination thereof, and a second gas selected from the group consisting of a hydrocarbon gas, a fluorocarbon gas, or a combination thereof.

The hydrocarbon gas may be CH₄ or C₂H₂, and the fluorocarbon gas may be C₄F₈, CF₄, or a combination thereof.

According to yet another embodiment of the present invention, the plasma treatment may be performed by blowing in a first gas selected from the group consisting of argon, nitrogen, oxygen, helium, and a combination thereof, and a second gas selected from the group consisting of CF₄ gas, C₄F₈ gas, and a combination thereof.

According to still another embodiment of the present invention, a fuel cell system including at least one electricity generating element that generates electricity through oxidation of a fuel and reduction of an oxidizing agent, a fuel supplier that supplies the electricity generating element with a fuel, and an oxidant supplier that supplies the electricity generating element with an oxidant is provided.

The electricity generating element includes at least one membrane-electrode assembly including an anode and a cathode facing each other and a polymer electrolyte membrane interposed between the anode and the cathode, and a separator.

The polymer electrolyte membrane has a junction with the anode and a binder included in the cathode.

The polymer electrolyte membrane may have a first surface contacting the anode and a second surface contacting the cathode, and the first or second surface may have a contact angle ranging from 80° to 180°. In addition, the first or second surface may have a contact angle ranging from 80° or more and less than 120°. Furthermore, the second surface may have a contact angle ranging from 80° to 180°, and both of the first and second surfaces may have a contact angle ranging from 80° to 180°.

Therefore, the present invention may provide a polymer electrolyte membrane that maintains internal moisture content and has dimensional stability and simultaneously improves properties of a fuel cell, and also increases a junction with a binder, particularly, a junction with a commercially available fluorine-based binder, and thus improves electrochemical performance and long-term performance of a membrane-electrode assembly.

### BRIEF DESCRIPTION OF THE DRAWINGS

FIG. 1 provides a drawing illustrating the junction of an electrode with a polymer electrolyte membrane according to one embodiment of the present invention.

FIG. 2 provides a drawing schematically illustrating the structure of a fuel cell system according to one embodiment of the present invention.

FIG. 3 is a graph showing water content ratio of the polymer electrolyte membranes according to Examples 1 and 2 and Comparative Examples 1 and 2.

FIG. 4 is a graph showing dimensional stability of the polymer electrolyte membranes according to Examples 1 and 2 and Comparative Examples 1 and 2.

FIG. 5 is a graph showing cell performance of each unit respectively including the polymer electrolyte membranes according to Examples 1 and 2 and Comparative Example 1.

FIG. 6 is a graph showing cell performance of each unit cell fabricated according to Examples 6 to 8 and Comparative Examples 3 and 9 under relative humidity of 100%.

FIG. 7 is a graph showing performance of each unit cell according to Examples 6 to 8 and Comparative Example 3 under relative humidity of 65%.

FIG. 8 is a graph showing performance of each unit cell according to Examples 6 to 8 and Comparative Example 3 under relative humidity of 45%.

FIG. 9 is a graph showing cell performance of each unit cell according to Comparative Examples 3 and 6 to 9 under relative humidity of 100%.

FIG. 10 is a graph showing cell performance of each unit cell according to Comparative Examples 3 and 6 to 8 under relative humidity of 65%.

FIG. 11 is a graph showing cell performance of each unit cell according to Comparative Examples 3 and 6 to 8 under relative humidity of 45%.

FIG. 12 provides a graph showing cell performance of a unit cell according to Comparative Example 12 at 70° C. under various relative humidity conditions.

FIG. 13 is a graph showing cell performance of a unit cell according to Comparative Example 13 at 70° C. under various relative humidity conditions.

FIG. 14 is a graph showing cell performance of a unit cell according to Comparative Example 14 at 70° C. under various relative humidity conditions.

FIG. 15 is a graph showing cell performance of a unit cell according to Comparative Example 15 at 70° C. under various relative humidity conditions.

FIG. 16 is a graph showing cell performance of a unit cell according to Comparative Example 12 at 80° C. under various relative humidity conditions.

FIG. 17 is a graph showing cell performance of a unit cell according to Comparative Example 13 at 80° C. under various relative humidity conditions.

FIG. 18 is a graph showing cell performance of a unit cell according to Comparative Example 14 at 80° C. under various relative humidity conditions.

FIG. 19 is a graph showing cell performance of a unit cell according to Comparative Example 15 at 80° C. under various relative humidity conditions.

### DETAILED DESCRIPTION OF THE EMBODIMENTS

The present invention will be more fully described hereinafter, in which exemplary embodiments are shown. This invention may, however, be embodied in many different forms and is not be construed as limited to the exemplary embodiments set forth herein.

According to one embodiment of the present invention, a polymer electrolyte membrane for a polymer electrolyte fuel cell is a polymer membrane made of a hydrocarbon-based proton conductive polymer. The polymer electrolyte membrane has a surface contact angle ranging from 80° to 180°, and thus may be hydrophobic. In addition, the polymer electrolyte membrane may have a surface contact angle between 80° or more, and less than 120°, and thus may be somewhat hydrophobic.

When the polymer electrolyte membrane has a contact angle of less than 80°, the polymer electrolyte membrane may have a problem of being expanded during the hydration and thus peeled off from a catalyst layer including a binder.

In this way, when a polymer electrolyte membrane has a surface contact angle ranging from 80° to 180° and is hydrophobic, it may have an excellent junction with catalyst layers of an anode and a cathode. The junction property may become maximized when a fluorine-based binder is used. This reason why that a binder included in a catalyst layer makes a junction of the catalyst of an anode and a cathode with a polymer electrolyte membrane, and since a generally-used binder is a fluorinated resin and is hydrophobic, it has excellent compatibility with the surface of a hydrophobic polymer electrolyte and further improves the junction therewith. In this way, when the catalyst layer of an electrode has an excellent junction with a polymer electrolyte membrane, a fuel cell may have improved long-term stability.

In the present invention, a surface indicates a depth from the outmost surface of a polymer electrolyte membrane (a surface contacting an anode or a cathode) to about 10% of the entire thickness of the polymer electrolyte membrane based on 100% of the entire thickness of the polymer electrolyte membrane in a depth direction (toward an opposing electrode). The surface may indicate about 5% of the depth from the outmost surface of the polymer electrolyte membrane.

In other words, a polymer electrolyte membrane according to one embodiment of the present invention may be controlled to have a hydrophobic surface property (e.g., weak hydrophobic or superhydrophobic) but maintain internal properties. When a polymer electrolyte membrane has the same hydrophobic internal property as the surface, it may have deteriorated proton conductivity.

Accordingly, a polymer electrolyte membrane may have a surface angle contacting an electrode in a range of 80° to 180°, and thus may be hydrophobic. The contact angle between 80° or more and less than 120° indicates weak hydrophobicity, while the one ranging from 120° to 180° indicates superhydrophobicity. According to one embodiment of the present invention, the surface contact angle between 80° or more and less than 120° and indicating weak hydrophobicity may be appropriate for the polymer electrolyte membrane.

When the polymer electrolyte membrane has a surface contact angle ranging from 80° to 180°, it may have an excellent junction with a binder used in a catalyst layer, and particularly an excellent junction with a generally-used fluorine-based binder, and thus may decrease interface resistance against an electrode, and furthermore, the polymer electrolyte membrane has improved dimensional stability and thus may be less peeled off from the catalyst layer including a binder, resultantly improving electrochemical performance and long-term stability. In particular, when a polymer electrolyte membrane has a surface contact angle between 80° or more and less than 120° and thus has weak hydrophobicity, it may more effectively improve power density of a fuel cell.

The hydrocarbon-based proton conductive polymer may include any hydrocarbon-based polymer resin with proton conductivity, and in particular, all hydrocarbon-based polymer resins having a cation exchange group selected from the group consisting of a sulfonic acid group, a carboxylic acid group, a phosphoric acid group, a phosphonic acid group, and derivatives thereof at the side chain. Examples of the polymer may include a hydrocarbon-based polymer selected from a benzimidazole-based polymer, a benzoxide-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer or a polyphenylquinoxaline-based polymer, a copolymer thereof, or a combination thereof.

Examples of the polymer resin may include at least one selected from polyetheretherketone, polypropylene oxide, a polyacrylic acid-based ionomer, polyarylene ether sulfone, sulfonated polyarylene ether sulfone, sulfonated polyether ether ketone, sulfonated polyphosphazene, sulfonated poly arylene sulfide, sulfonated polyarylene sulfide, polybenzoxazole, poly(2,2′-m-phenylene)-5,5′-bibenzimidazole, and poly(2,5-benzimidazole). Of course, the polymer resin has the aforementioned cation exchange group at the side chain.

According to one embodiment of the present invention, the hydrophobic treatment on the surface of a polymer electrolyte membrane may work better with a hydrocarbon-based polymer than a fluorine-based polymer as a proton conductive polymer.

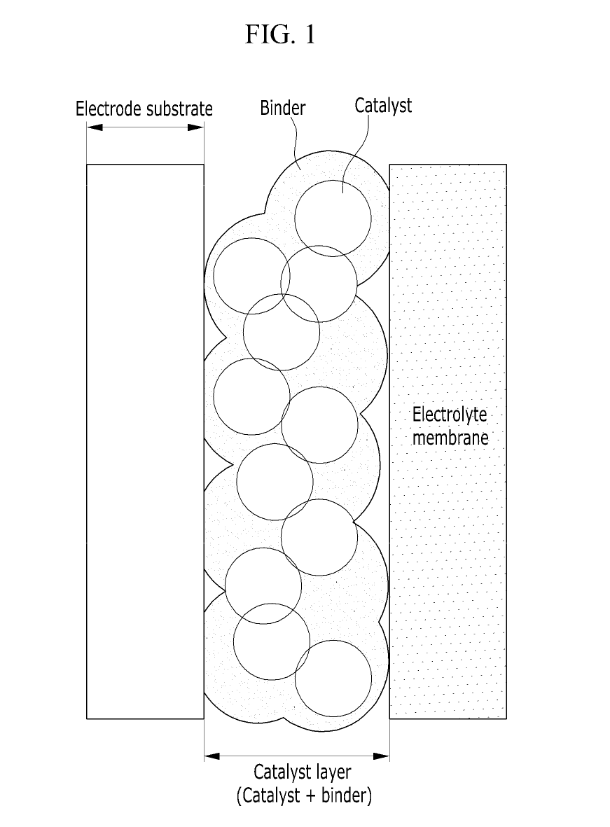

In a fuel cell, a polymer electrolyte membrane contacts an electrode with a catalyst on an electrode substrate through a binder in the catalyst as shown in FIG. 1. Herein, the polymer electrolyte membrane made of a hydrocarbon-based polymer has bad compatibility with a binder in the catalyst layer, and particularly a fluorine-based binder, and thus, may be more easily peeled off from the catalyst layer on the electrode than a polymer electrolyte membrane made of a fluorine-based polymer. This layer-separation problem may be solved by adjusting the surface of a polymer electrolyte membrane to be hydrophobic, similar to a fluorine-based binder in the catalyst layer, thus improving compatibility of the polymer electrolyte membrane with the catalyst layer of an electrode and resultantly the junction of the polymer electrolyte membrane with the catalyst layer is more improved, and this effect may become maximized when a the polymer electrolyte membrane made of a hydrocarbon-based polymer is used.

In addition, the proton conductive polymer may include a proton conductive group including Na, K, Li, Cs, or tetrabutyl ammonium substituted for H. When H in the proton conductive group of a proton conductive polymer is substituted with Na,NaOH or NaCl is used, when H is substituted with tetrabutylammonium, tetrabutylammonium hydroxide is used, and the proton conductive group may be substituted with K, Li, or Cs using an appropriate compound. This substitution is well-known in this related field and will not be illustrated in detail. In addition, when Na, K, Li, Cs, or tetrabutyl ammonium is substituted for H, a polymer electrolyte membrane may be acid-treated and transformed into a H⁺ form polymer electrolyte membrane.

Furthermore, a polymer electrolyte membrane according to one embodiment of the present invention may be effectively applied to a polymer electrolyte type fuel cell. If the polymer electrolyte membrane according to one embodiment of the present invention is applied to a direct oxidation fuel cell that constantly maintains a hydration state of the membrane by using a liquid fuel such as methanol, it may have little effect or rather deteriorated effects.

As for a polymer electrolyte type fuel cell, a polymer electrolyte membrane may be continuously changed in a hydration state due to water produced from reaction of the fuel cell, and may also have different humidifying degrees of a gas fuel such as hydrogen gas supplied to an anode and an oxidizing agent such as oxygen gas supplied to a cathode, and particularly unstable humidifying degrees when practically applied to the fuel cell, so that a polymer electrolyte membrane may be repeatedly swollen and contracted and thus peeled off.

This problem was thought to be suppressed when a polymer electrolyte membrane was treated to be hydrophilic, however, the problem may be effectively suppressed according to one embodiment of the present invention, when a polymer electrolyte membrane is treated to be hydrophobic. In other words, since a polymer electrolyte membrane according to one embodiment of the present invention has a surface contact angle exhibiting hydrophobic on the surface, the problem may be suppressed.

Furthermore, unlike a direct oxidation fuel cell that is well-equipped with a water channel for proton delivery since an electrolyte membrane is completely humidified by water included in a liquid fuel, a polymer electrolyte type fuel cell include relatively less water and is badly equipped with a proton channel and thus may inefficiently deliver protons, however, an electrolyte membrane according to one embodiment of the present invention may constantly maintain an internal hydration state.

According to another embodiment of the present invention, a method of manufacturing the polymer electrolyte membrane is provided. The manufacturing method may include hydrophobic-treatment of a hydrocarbon-based proton conductive polymer membrane by using plasma. The plasma treatment modifies the surface of the polymer electrolyte membrane by exposing the surface of the polymere electrolyte membrane to partially-ionized gas in a plasma state, and since the modification occurs on a very small surface, the polymer electrolyte membrane itself may not only be treated without damage or a large property change, but may also have few pollutants. Hereinafter, the plasma treatment will be illustrated in more detail.

A hydrocarbon-based proton conductive polymer membrane is placed on a sample stage in a plasma chamber. Herein, one side of the hydrocarbon-based proton conductive polymer membrane is placed toward a plasma generator with the other side toward the bottom of the sample stage in order to plasma-treat one side thereof. The one side indicates one surface of a proton conductive polymer membrane in a length direction, in other words, the surface contacting a cathode or an anode when a membrane-electrode assembly is fabricated. The proton conductive polymer membrane is made of the aforementioned proton conductive polymer.

In this way, one surface of a proton conductive polymer membrane is plasma-treated, but the other side may be plasma-treated after plasma-treating the one side in the same method.

Next, the plasma treatment is performed by blowing in a first gas selected from argon gas, nitrogen gas, oxygen gas, helium gas, or a combination thereof, and a second gas selected from hydrocarbon gas, fluorocarbon gas, or a combination thereof. According to one embodiment of the present invention, the plasma treatment may be performed by blowing in the second gas of fluorocarbon gas along with the first gas.

The hydrocarbon gas may be selected from CH₄ gas, C₂H₂ gas, or a combination thereof, and the fluorocarbon gas may be selected from CF₄ gas, C₄F₈ gas, or a combination thereof. When a mixed gas is used, the mixing ratio may be appropriately adjusted. In addition, the C₂H₂ gas may include a commercially-available gas such as C₂H₂/Ar gas, C₂H₂/He gas, or C₂H₂/N₂ gas. Herein, the mixing ratio of C₂H₂ gas with Ar, He, or N₂ gas may have no actual influence on the present invention and thus may be appropriately adjusted.

The plasma treatment may be performed by blowing in the first gas at a speed of 15 L/min to 30 L/min, and in another embodiment, 20 L/min to 25 L/min. When the first gas is blown in within the speed range, plasma may be well-formed and thus smoothly promote radical reaction of the second gas.

In the plasma treatment, the second gas may be blown in at a speed of 5 ml/min to 50 ml/min. Herein, when the second gas is blown in by changing a speed of 5 ml/min to 20 ml/min, and in particular, 10 ml/min to 15 mL/min, the polymer electrolyte membrane may have weak hydrophobicity, and when the second gas is blown in by changing the speed of 20 ml/min to 50 ml/min, the polymer electrolyte membrane may be superhydrophobic. When the second gas is blown in within the speed range, it may not disturb plasma formation of the first gas and appropriately have a radical reaction without wasting gas on the polymer surface.

According to one embodiment of the present invention, a polymer electrolyte membrane may have a surface contact angle that is adjusted depending on kinds of gas atmosphere for the plasma treatment.

For example, when the plasma treatment is performed by blowing in a first gas selected from argon gas, nitrogen gas, oxygen gas, helium gas, or a combination thereof and a second gas selected from CF₄ gas, C₄F₈ gas, and a combination thereof, a polymer electrolyte membrane may have a surface contact angle between 80° or more, and less than 120° and thus appear weakly hydrophobic.

In addition, when the plasma treatment is performed by blowing in a first gas selected from argon gas, nitrogen gas, oxygen gas, helium gas, or a combination thereof and a second gas selected from C₂H₂ gas, CF₄ gas, C₄F₈ gas, or a combination thereof, a polymer electrolyte membrane may have a surface contact angle ranging from 120° to 180° and thus appear superhydrophobic.

Accordingly, the plasma treatment in the present invention may be performed by blowing in a first gas selected from argon gas, nitrogen gas, oxygen gas, helium gas, or a combination thereof and a second gas selected from CF₄ gas, C₄F₈ gas, and a combination thereof.

In this way, a polymer electrolyte membrane may have surface properties that are easily adjusted for a desired purpose.

Accordingly, a polymer electrolyte membrane may have a hydrophobic surface property with a contact angle ranging from 80° to 180°, for example, a weak hydrophobic property with a contact angle between 80° or more, and less than 120° and a superhydrophobic property with a contact angle ranging from 120° to 180°, and the polymer electrolyte membrane may maintain an internal proton conductive polymer membrane property. When a polymer electrolyte membrane has a hydrophobic internal property within the range, that is to say, when a polymer electrolyte membrane is prepared to include a hydrophobic material, the polymer electrolyte membrane may have too low water content ratio, deteriorating proton conductivity, but a polymer electrolyte membrane according to one embodiment of the present invention may not have this problem.

According to another embodiment of the present invention, a polymer electrolyte fuel cell system is provided.

The fuel cell system includes an electricity generating element, a fuel supplier, and an oxidizing agent supplier. The electricity generating element generates electricity through oxidation of a fuel and reduction of an oxidizing agent. The fuel supplier plays a role of supplying the electricity generating element with a fuel, and the oxidizing agent supplies the electricity generating element with an oxidizing agent. The oxidizing agent may include oxygen or air. In addition, the fuel may include a gas or a liquid hydrogen fuel.

The electricity generating element includes at least one membrane-electrode assembly including an anode and a cathode facing each other and a polymer electrolyte membrane interposed between the anode and cathode, and a separator. The polymer electrolyte membrane may have a junction with a binder included in the anode and the cathode. The polymer electrolyte membrane is a polymer electrolyte membrane according to one embodiment of the present invention, and will be illustrated in more detail.

The polymer electrolyte membrane may have a first surface contacting the anode and a second surface contacting the cathode, and at least either of the first and second surfaces may have a contact angle ranging from 80° to 180°. In addition, at least either of the first and second surfaces may have a contact angle between 80° or more, and less than 120°.

According to one embodiment of the present invention, the second surface may have a contact angle in a range of 80° to 180°, but in another embodiment, between 80° or more, and less than 120°. When the second surface has a contact angle within the range, a cathode has a higher water concentration than an anode, more effectively suppressing swelling of an electrolyte membrane, deterioration of a proton concentration, and water flooding in the electrode membrane.

In addition, both of the first and second surfaces have a contact angle ranging from 80° to 180°, but in another embodiment, between 80° or more, and less than 120°. When the first and second surfaces both have a contact angle within the range, a polymer electrolyte membrane may be effectively suppressed from swelling, proton concentration deterioration, and water flooding, and may have a better contact property with an electrode, remarkably decreasing the entire interface resistance and effectively suppressing moisture loss from inside of the electrolyte membrane, so that a polymer electrolyte-type fuel cell with excellent chemical cell performance is provided.

The cathode and anode include an electrode substrate and a catalyst layer, respectively.

The catalyst layer may include any catalyst participating in a fuel cell reaction, for example, a platinum-based catalyst. The platinum-based catalyst may be at least one selected from the group consisting of platinum, ruthenium, osmium, a platinum-ruthenium alloy, a platinum-osmium alloy, a platinum-palladium alloy, or a platinum-M alloy (M is at least one transition element selected from the group consisting of Ga, Ti, V, Cr, Mn, Fe, Co, Ni, Cu, Zn, Sn, Mo, W, Rh, and Ru).

Such a metal catalyst may be used in a form of a metal itself (black catalyst), or may be used by being supported on a carrier. The carrier may include carbon such as graphite, denka black, ketjen black, acetylene black, carbon nanotubes, carbon nanofiber, carbon nanowire, carbon nanoballs, activated carbon, and so on, or an inorganic particulate such as alumina, silica, zirconia, titania, and so on, and the carbon is generally used in the art. A noble metal supported on a carrier may be a commercially available one or can be prepared by supporting a noble metal on a carrier. The method of supporting a noble metal on a carrier is well-known in this related field, so that it is well understood to one of ordinary skilled in the art, though a detailed description thereof is omitted.

The catalyst layer may further include a binder to improve adherence between a polymer electrolyte membrane and an electrode and to transfer protons.

The binder may be proton conductive polymer resins having a cation exchange group selected from the group consisting of a sulfonic acid group, a carboxylic acid group, a phosphoric acid group, a phosphonic acid group, and derivatives thereof at its side chain. Examples of the binder include at least one proton conductive polymer selected from the group consisting of a fluorine-based polymer, a benzimidazole-based polymer, a benzoxide-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer, or a polyphenylquinoxaline-based polymer.

The proton conductive polymer includes at least one selected from the group consisting of poly(perfluorosulfonic acid) (commercially available Nafion), poly(perfluorocarboxylic acid), a sulfonic acid group-containing copolymer of tetrafluoroethylene and fluorovinylether, sulfonated polyarylene ether sulfone, sulfonated polyether ether ketone, sulfonated polyphosphazene, sulfonated polyarylene sulfide, sulfonated polyarylene sulfide, polybenzoxazole, poly(2,2′-m-phenylene)-5,5′-bibenzimidazole, or poly(2,5-benzimidazole).

The hydrogen (H) in the cation exchange group of the proton conductive polymer may be substituted with Na, K, Li, Cs, or tetrabutylammonium. When the H in the cation exchange group at the terminal end of the proton conductive polymer side chain is substituted with Na, NaOH or NaCl may be used; when the H is substituted with tetrabutylammonium, tetrabutylammonium hydroxide may be used during preparation of the catalyst composition; and when the H is substituted with K, Li, or Cs, suitable compounds for the substitutions may be used. Since such a substitution is known to this art, a detailed description thereof is omitted.

The binder may be used singularly or in a combination, and the binder may be used along with non-conductive polymers to improve adherence with a polymer electrolyte membrane. The binder may be used in a controlled amount depending on the purpose.

Preferred examples of the non-conductive compound include one selected from the group consisting of polytetrafluoroethylene (PTFE), a tetrafluoroethylene-hexafluoropropylene copolymer (FEP), a tetrafluoroethylene-perfluoro alkylvinylether copolymer (PFA), ethylene/tetrafluoroethylene (ETFE), an ethylenechlorotrifluoro-ethylene copolymer (ECTFE), polyvinylidene fluoride, a polyvinylidene fluoride-hexafluoropropylene copolymer (PVdF-HFP), dodecylbenzene sulfonic acid, and sorbitol.

In a fuel cell, an electrode substrate plays a role of supporting an electrode and diffusing a fuel and an oxidant into a catalyst layer, so that the fuel and the oxidant may easily approach the catalyst layer. The electrode substrates are formed of a material such as carbon paper, carbon cloth, carbon felt, or a metal cloth (a porous film composed of metal fiber or a metal film disposed on the surface of a cloth composed of polymer fibers), but the electrode substrate is not limited thereto.

The electrode substrate may be treated with a fluorine-based resin to be water-repellent to prevent deterioration of diffusion efficiency due to water generated during operation of a fuel cell. The fluorine-based resin may include polytetrafluoroethylene, polyvinylidene fluoride, polyhexafluoropropylene, polyperfluoroalkyl vinylether, polyperfluoro sulfonylfluoride alkoxyvinyl ether, fluorinated ethylene propylene, polychlorotrifluoroethylene, or a copolymer thereof.

In addition, a microporous layer may be further positioned to increase reactant diffusion effects in the electrode substrate. The microporous layer generally includes conductive powders with a certain particle diameter. The conductive material may include, but is not limited to, carbon powder, carbon black, acetylene black, ketjen black, activated carbon, carbon fiber, fullerene, nano-carbon, or combinations thereof. The nano-carbon may include a material such as carbon nanotubes, carbon nanofiber, carbon nanowire, carbon nanohorns, carbon nanorings, or combinations thereof.

The microporous layer is formed by coating a composition including a conductive powder, a binder resin, and a solvent on the conductive substrate. The binder resin may include polytetrafluoroethylene, polyvinylidene fluoride, polyhexafluoropropylene, polyperfluoroalkylvinylether, polyperfluorosulfonyl fluoride, alkoxyvinyl ether, polyvinyl alcohol, cellulose acetate, or copolymers thereof. The solvent may include an alcohol such as ethanol, isopropyl alcohol, n-propyl alcohol, butanol, and so on, water, dimethyl acetamide, dimethyl sulfoxide, N-methylpyrrolidone, or tetrahydrofuran. The coating method may include, but is not limited to, screen printing, spray coating, doctor blade methods, gravure coating, dip coating, silk screening, painting, and so on, depending on the viscosity of the composition.

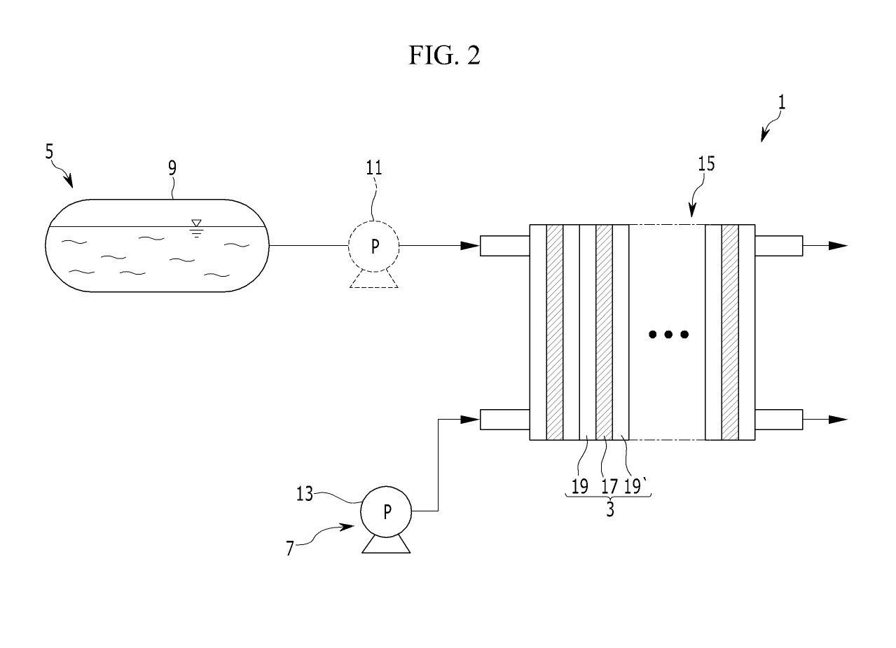

FIG. 2 shows the schematic structure of a fuel cell system that will be described in detail with reference to this accompanying drawing as follows. FIG. 2 illustrates a fuel cell system in which a fuel and an oxidant are provided to the electricity generating element through pumps, but the present invention is not limited to such structures, and the fuel cell system of the present invention alternatively includes a structure wherein a fuel and an oxidant are provided in a diffusion manner.

A fuel cell system 1 includes at least one electricity generating element 3 that generates electrical energy through the electrochemical reaction of a fuel and an oxidant, a fuel supplier 5 for supplying a fuel to the electricity generating element 3, and an oxidant supplier 7 for supplying an oxidant to the electricity generating element 3.

In addition, the fuel supplier 5 is equipped with a tank 9 that stores a fuel, and a fuel pump 11 that is connected therewith. The fuel pump 11 supplies the fuel stored in the tank 9 with a predetermined pumping power.

The oxidant supplier 7, which supplies the electricity generating element 3 with an oxidant, is equipped with at least one pump 13 for supplying the oxidant with a predetermined pumping power.

The electricity generating element 3 includes a membrane-electrode assembly 17 that oxidizes hydrogen or a fuel and reduces an oxidant, separators 19 and 19′ that are respectively positioned at opposite sides of the membrane-electrode assembly and supply hydrogen or a fuel and an oxidant, and at least one electricity generating element 3 is composed in a stack 15.

The following examples illustrate the present invention in more detail. However, it is understood that the present invention is not limited by these examples.

### Example 1

A 35 μm-thick proton conductive polymer membrane formed of a polymer resin including a first repeating unit represented by the following Chemical Formula 1a and a second repeating unit represented by the following Chemical Formula 1b in a mole ratio of 4:6 was put on a sample stage with one side toward a plasma generator and the opposite side toward the bottom of the sample stage in a plasma chamber.

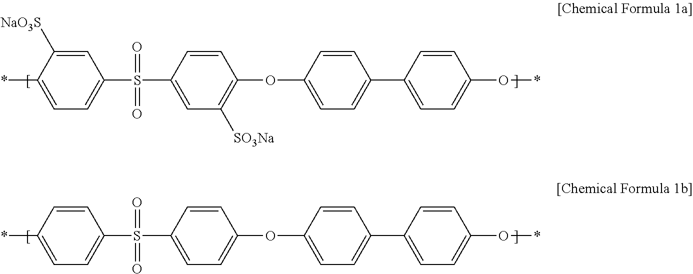

Next, the proton conductive polymer membrane was plasma-treated by blowing in helium gas at a speed of 25 L/min and C₄F₈ gas at a speed of 15 ml/min to form an electrolyte membrane with a hydrophobic surface on one side.

Then, the other side of the electrolyte membrane (opposited to the one side hydrophobic-treated) with the one side hydrophobic-treated was plasma-treated under the same conditions, acquiring a polymer electrolyte membrane for a fuel cell having a hydrophobic surface on both sides.

In the polymer electrolyte membrane, the hydrophobic surface treatment was performed to be 50 nm deep from the outermost of the surface.

### Example 2

A 35 μm-thick proton conductive polymer membrane formed of the polymer resin used in Example 1 was placed on a sample stage with one side toward a plasma generator and the other side toward the bottom of the sample stage in a plasma chamber.

Next, the proton conductive polymer membrane was plasma-treated by blowing in helium gas at a speed of 25 L/min and C₂H₂ gas, C₄F₈ gas, and C₄F₈ gas at respective speeds of 50 ml/min, 10 ml/min, and 15 ml/min, fabricating a polymer electrolyte membrane with one superhydrophobic surface.

Then, the other side which does not undergo superhydrophobic surface treatment (opposed to the superhydrophobic surface) of the electrolyte membrane with one side superhydrophobic surface treated, was also plasma-treated under the same conditions, acquiring a polymer electrolyte membrane for a fuel cell with a superhydrophobic surface on both sides.

In the polymer electrolyte membrane, the superhydrophobic surface treatment was performed to be 110 nm deep from the outermost surface.

### Comparative Example 1

The same 35 μm-thick proton conductive polymer membrane made of a polymer resin as used in Example 1 was used as a polymer electrolyte membrane for a fuel cell.

### Comparative Example 2

A polymer electrolyte membrane for a fuel cell having one hydrophilic surface was fabricated according to the same method as Example 1, except for plasma-treating the same 35 μm-thick proton conductive polymer membrane made of a polymer resin as used in Example 1 by respectively blowing in nitrogen gas and oxygen gas at a speed of 10 ml/min under air atmosphere. In the polymer electrolyte membrane, the hydrophilic surface treatment was performed to be 0.2 nm deep from the outermost surface.

Surface Contact Angle Measurement

The polymer electrolyte membranes according to Examples 1 and 2 and Comparative Examples 1 and 2 were measured regarding surface contact angle against distilled water, and the results were 109.3° (weak hydrophobic), 137.2° (superhydrophobic), 86.3° (hydrophilic: a polymer electrolyte membrane with no hydrophobic treatment), and 78.4° (hydrophilic). Herein, the surface angle was measured using a commercially available equipment (DIGIDROP, GBX), by dropping a small water dropon the surface of a polymer electrolyte membrane with a thin needle, and then observing regarding the shape to measure the angle of the inside of the water drop against the surface of the membrane.

Cell Performance Measurement

The polymer electrolyte membranes according to Examples 1 and 2 and Comparative Example 1 were respectively used to fabricate a membrane-electrode assembly in a common method, and the membrane-electrode assembly was used to fabricate a unit cell.

Herein, a cathode and an anode was used, and the cathode and the anode was prepared by screen-printing a catalyst composition including 0.3 g of a Pt/C (Pt supported in carbon, 20 wt % of Pt and 80 wt % of carbon) catalyst and 0.495 g of a Nafion binder (a concentration of 5 wt % Nafion/H₂O/isopropanol) on a carbon paper electrode substrate including a microporous layer, 35 BC, made by SGL Group. The anode and the cathode were respectively loaded with platinum in an amount of 0.3 mg/cm².

1) Current Density and Power Density Measurement

The unit cell was measured regarding current density and power density under conditions of 0.6V and 0.5V, 65° C., and 100% humidity, and the results are provided in the following Table 1. Herein, as for a fuel, H₂ was used under a condition of 100 ccm (cubic centimeters per minute), while as for an oxidizing agent, O₂ was used under a condition of 100 ccm.

TABLE 1

| | 0.6 V | | 0.5 V | |
|---|---|---|---|---|
| | Current | | Current | |
| | density | Power density | density | Power density |
| | (mA/cm²) | (W/cm²) | (mA/cm²) | (W/cm²) |
| Example 1 | 900 | 0.54 | 1300 | 0.65 |
| Example 2 | 600 | 0.36 | 850 | 0.425 |
| Comparative | 350 | 0.24 | 800 | 0.4 |
| Example 1 | | | | |

As shown in Table 1, each fuel cell including the polymer electrolyte membranes with a surface contact angle of respectively 109.3° and 137.2° according to Examples 1 and 2 had excellent current density and power density compared with a fuel cell including the polymer electrolyte membrane with a surface contact angle of 86.3° according to Comparative Example 1. In other words, when a polymer electrolyte membrane has a surface contact angle ranging from 90° to 180°, a fuel cell has improved current density and power density.

2) Water Content Ratio Measurement

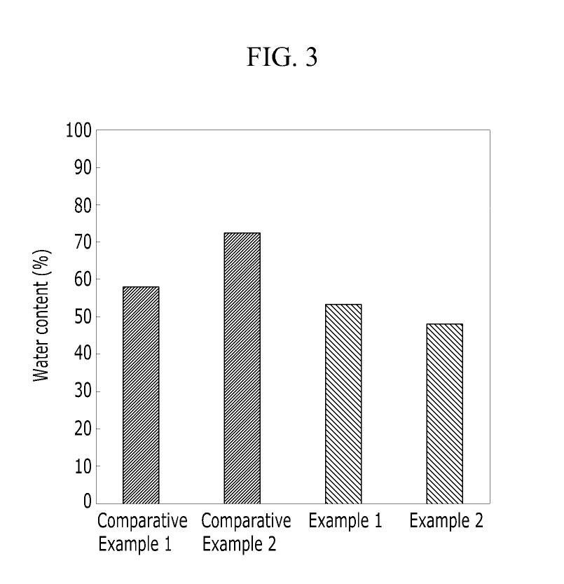

The polymer electrolyte membranes according to Examples 1 and 2 and Comparative Examples 1 and 2 were measured regarding water content ratio at 30° C., and the results are provided in FIG. 3. The water content ratio was measured by sufficiently drying the polymer electrolyte membrane in a 110° C. vacuum-oven and then weighing it. Then, the polymer electrolyte membrane was dipped in 30° C. ultrapure water for sufficient hydration and then the weight of the hydrated membrane was weighed, following calculating it according to the following Equation 1.

Water content ratio=(weight of a hydrated membrane−weight of a dried membrane)/weight of a dried membrane×100 [Equation 1]

As shown in FIG. 3, the polymer electrolyte membranes of Examples 1 and 2 had a somewhat decreased water content ratio compared with the polymer electrolyte membrane of Comparative Example 1. However, the polymer electrolyte membranes did to have a large difference overall. Accordingly, even if the polymer electrolyte membrane has a hydrophobic surface, it has a relatively low water content ratio change. The polymer electrolyte membrane of Comparative Example 2 became more hydrophilic and had a further increased water content ratio compared with the one of Comparative Example 1.

3) Dimensional Stability

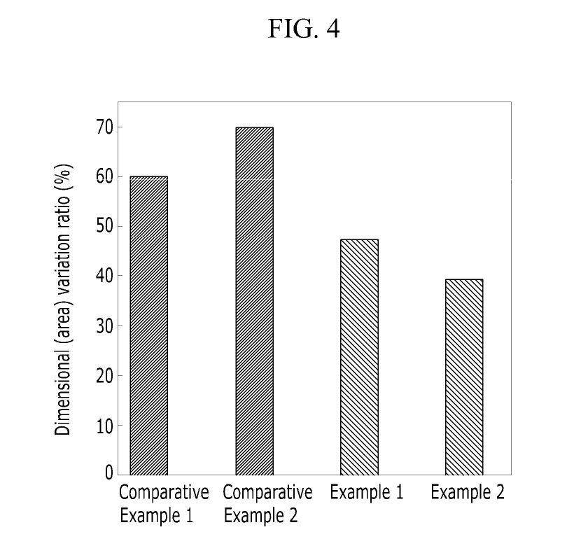

The polymer electrolyte membranes according to Examples 1 and 2 and Comparative Examples 1 and 2 were measured regarding dimensional stability, and the results are provided in FIG. 4. The dimensional stability was evaluated by measuring dimensional (area) change of the polymer electrolyte membranes before and after hydration, and a smaller dimensional (area) change may bring about higher dimensional stability. The dimensional change is measured as follows.

The polymer electrolyte membrane was sufficiently dried in a 110° C. vacuum oven and measured regarding area thereof. Then, the dried polymer electrolyte membrane was dipped in 30° C. ultrapure water for a day for sufficient hydration and measured regarding area, and then, its dimensional stability was calculated according to the following Equation 2.

Dimension variation ratio=(area of a hydrated membrane−area of a dried membrane)/area of a dried membrane×100 [Equation 2]

As shown in FIG. 4, the polymer electrolyte membranes according to Examples 1 and 2 had better dimensional stability than the ones according to Comparative Examples 1 and 2.

4) Cell Performance Measurement of a Unit Cell

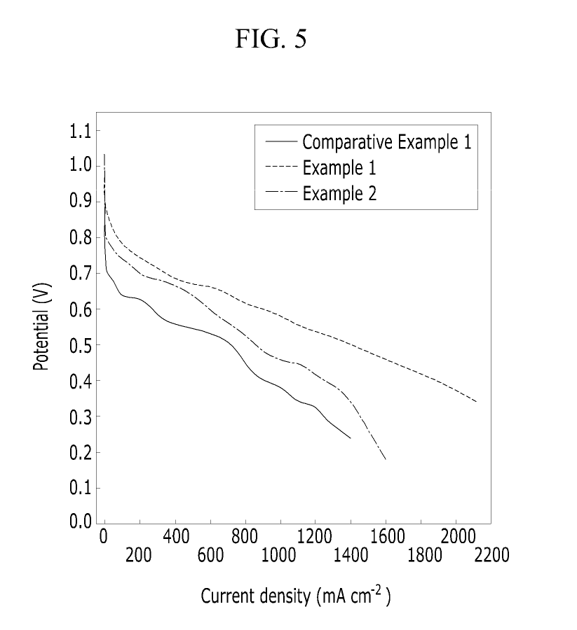

Unit cells including the polymer electrolyte membranes according to Examples 1 and 2 and Comparative Example 1 were measured regarding cell performance, and the results are provided in FIG. 5. As shown in FIG. 5, when the polymer electrolyte membranes with weak hydrophobic and superhydrophobic surfaces (Examples 1 and 2) were compared with the polymer electrolyte membrane with a hydrophilic surface according to Comparative Example 1, the unit cells including the polymer electrolyte membranes of Examples 1 and 2 had higher performance. The reason is that the polymer electrolyte membranes according to Examples 1 and 2 were hydrophobic on the surface and thus had a good junction with the Nafion binder of a hydrophobic catalyst layer and decreased resistance between electrode/fluorine-based polymer binder/polymer electrolyte membrane, and in addition, as shown in FIGS. 3 and 4, it had high dimensional stability without remarkably decreasing water content ratio that determines proton conductivity.

### Example 3

A 35 μm-thick proton conductive polymer membrane made of a polymer resin including a first repeating unit represented by the following Chemical Formula 1a and a second repeating unit represented by the following Chemical Formula 1b in a mole ratio of 4:6 was placed on a sample stage with one side toward a plasma generator and the other side toward the bottom of the sample stage in a plasma chamber.

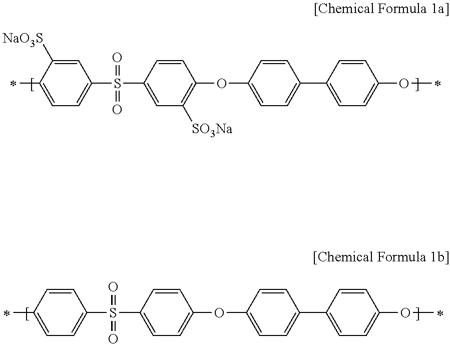

Next, the proton conductive polymer membrane was plasma-treated by blowing in helium and C₄F₈ gas at respective speeds of 25 L/min and 10 ml/min, preparing a polymer electrolyte membrane for a fuel cell having one hydrophobic surface. The hydrophobic surface treatment was performed to be 0.2 nm deep from the outermost surface.

### Example 4

A polymer electrolyte membrane with both hydrophobic surfaces for a fuel cell was prepared by performing the same surface treatment as Example 3 on the other side (facing the hydrophobic surface) of the polymer electrolyte membrane with one side hydrophobic surface treated of Example 3. In the polymer electrolyte membrane, the hydrophobic surfaces were treated to be respectively 0.2 nm deep from the outermost surfaces.

### Example 5

A polymer electrolyte membrane having only one superhydrophobic surface for a fuel cell was prepared according to the same method as Example 3, except for blowing in helium, C₄F₈ gas, and C₂H₂/Ar gas at respective speeds of 25 L/min, 10 ml/min, and 50 ml/min for plasma treatment. In the polymer electrolyte membrane, the superhydrophobic surface treatment was performed to be 110 nm deep from the outermost surface.

### Example 6

A cathode with a cathode catalyst layer was fabricated by screen-printing a catalyst composition including 0.3 g of a Pt/C (Pt supported in carbon, 20 wt % of Pt and 80 wt % of carbon) catalyst and 0.495 g of a Nafion binder (a concentration of 5 wt % Nafion/H₂O/isopropanol) on a carbon paper electrode substrate having a microporous layer, 35BC, made by SGL Group.

On the other hand, an anode with an anode catalyst layer was fabricated by screen-printing a catalyst composition including 0.3 g of a Pt/C (Pt supported in carbon, 20 wt % of Pt and 80 wt % of carbon) catalyst and 0.495 g of a Nafion binder (a concentration of 5 wt % Nafion/H₂O/isopropanol) on a carbon paper electrode substrate having a microporous layer, 35BC, made by SGL Group.

The anode and the cathode were loaded with platinum in respective amounts of 0.3 mg/cm².

Then, a polymer electrolyte membrane according to Example 3 was disposed between the cathode and the anode, and a membrane-electrode assembly was fabricated in a common method, and the membrane-electrode assembly was used to fabricate a unit cell. Herein, the hydrophobic surface of the polymer electrolyte membrane was disposed to contact the anode catalyst layer of the anode.

### Example 7

A unit cell was fabricated according to the same method as Example 6, except for disposing the hydrophobic surface of a polymer electrolyte membrane to contact the cathode catalyst layer of a cathode.

### Example 8

A unit cell was fabricated according to the same method as Example 6, except for using the polymer electrolyte membrane with both hydrophobic surfaces according to Example 4.

### Comparative Example 3

A polymer electrolyte membrane made of a polymer resin represented by the above Chemical Formula 1 was used. A unit cell was fabricated according to the same method as Example 6, except for using this polymer electrolyte membrane.

### Comparative Example 4

A polymer electrolyte membrane with one hydrophilic surface for a fuel cell was fabricated according to the same method as Example 3, except for plasma-treating a 35 μm-thick membrane made of a polymer resin represented by the above Chemical Formula 1 by blowing in nitrogen gas and oxygen gas at respective speeds of 10 ml/min and 15 ml/min. In the polymer electrolyte membrane, the hydrophilic surface treatment was performed to be 0.2 nm deep from the outermost surface.

### Comparative Example 5

A polymer electrolyte membrane with both hydrophilic surfaces was fabricated according to the same method as Comparative Example 4, by performing the same surface treatment on the other side opposing the hydrophilic surface of the polymer electrolyte membrane with one side hydrophilic surface treated of Comparative Example 4. In the polymer electrolyte membrane, the hydrophobic surface treatment was performed to be respectively 0.2 nm deep from the outermost surface.

### Comparative Example 6

A unit cell was fabricated according to the same method as Example 6, except for using the polymer electrolyte membrane of Comparative Example 4.

### Comparative Example 7

A unit cell was fabricated according to the same method as Example 7, except for using the polymer electrolyte membrane of Comparative Example 4.

### Comparative Example 8

A unit cell was fabricated according to the same method as Example 8, except for using the polymer electrolyte membrane of Comparative Example 5.

### Comparative Example 9

A unit cell was fabricated by using a commercially-available Nafion polymer electrolyte membrane (DuPont Co.) and an anode and a cathode according to Example 3 to fabricate a membrane-electrode assembly in a common method.

Surface Contact Angle Measurement

The polymer electrolyte membranes according to Examples 3 and 5 and Comparative Example 3 were measured regarding surface contact angle against distilled water, and as a result, the polymer electrolyte membrane of Example 3 had a surface contact angle of 85.3°, the one of Example 5 had a surface contact angle of 130°, and the one of Comparative Example 3 had a surface contact angle of 51.9°. In other words, the polymer electrolyte membrane of Example 3 was hydrophobic, the one of Example 5 was superhydrophobic, and the one of Comparative Example 3 was hydrophilic.

Cell Performance Measurement

The unit cells according to Examples 6 to 8 and Comparative Examples 3 and 9 were respectively operated with 0.6V and 0.5V and measured regarding current density and power density under relative humidity and cell temperature conditions provided in the following Table 2. The results of the unit cells according to Examples 6 to 8 and Comparative Examples 3 are provided in the following Table 3. In the following Table 3, RHXX indicates that relative humidity is XX %.

TABLE 2

| | | Fuel H₂ amount | Oxidizing agent O₂ |
|---|---|---|---|
| Relative | Cell temperature | supplied to | amount supplied to |
| humidity (%) | (° C.) | anode (ccm) | cathode (ccm) |
| 100 | 70 | 100 | 100 |
| 65 | 70 | 100 | 100 |
| 45 | 70 | 100 | 100 |

TABLE 3

| | | 0.6 V | | 0.5 V | |
|---|---|---|---|---|---|
| | | Current | Power | Current | Power |
| | | density | density | density | density |
| | RH (%) | (mA/cm²) | (W/cm²) | (mA/cm²) | (W/cm²) |
| Comparative | RH100 | 0.68 | 0.41 | 1.14 | 0.57 |
| Example 3 | RH65 | 0.53 | 0.32 | 1.01 | 0.51 |
| | RH45 | 0.25 | 0.15 | 0.57 | 0.29 |
| Example 6 | RH100 | 0.71 | 0.43 | 1.21 | 0.61 |
| | RH65 | 0.42 | 0.25 | 0.94 | 0.47 |
| | RH45 | 0.21 | 0.13 | 0.76 | 0.38 |
| Example 7 | RH100 | 0.81 | 0.48 | 1.19 | 0.6 |
| | RH65 | 0.44 | 0.26 | 0.89 | 0.45 |
| | RH45 | 0.41 | 0.24 | 0.79 | 0.39 |
| Example 8 | RH100 | 1.14 | 0.68 | 1.86 | 0.93 |
| | RH65 | 0.93 | 0.56 | 1.68 | 0.84 |
| | RH45 | 0.8 | 0.48 | 1.53 | 0.77 |

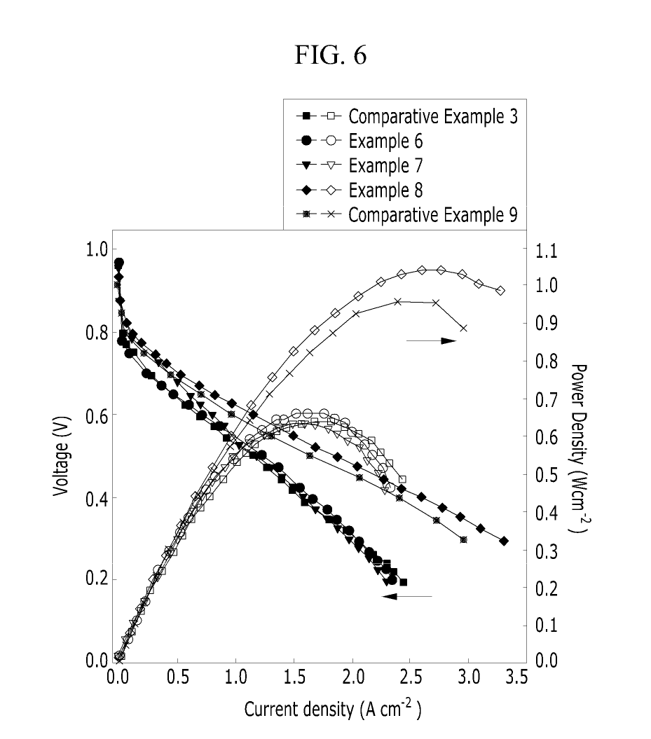

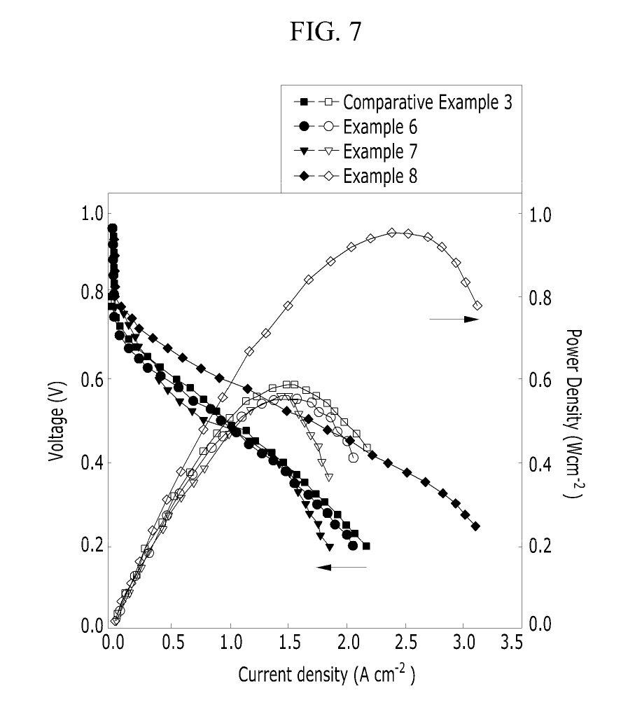

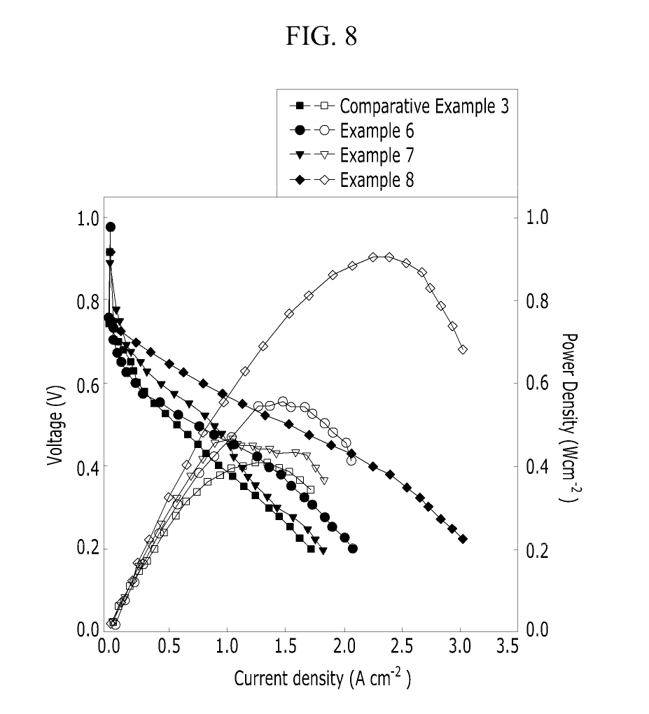

In addition, FIG. 6 shows the results of the unit cells according to Examples 6 to 8 and Comparative Examples 3 and 9 under relative humidity of 100%. Furthermore, FIG. 7 shows the results of the unit cells according to Examples 6 to 8 and Comparative Example 3 under relative humidity of 65%, and FIG. 8 shows the result according to Examples 6 to 8 and Comparative Example 3 under relative humidity of 45%.

As shown in Table 3 and FIG. 6, the unit cells of Examples 6 and 7 had somewhat better power density and current density than the one of Comparative Example 3 under relative humidity of 100%, and the cell of Example 8 had remarkably deteriorated power density and current density than the one of Comparative Example 3. In particular, the unit cell according to Example 8 had similar or higher power density and current density than the unit cell including a Nafion polymer electrolyte membrane according to Comparative Example 9, and when a polymer electrolyte membrane was surface-treated to be hydrophobic on both sides, a hydrocarbon-based polymer electrolyte membrane had similar or higher electrochemical performance than a Nafion membrane.

In addition, as shown in Table 3 and FIGS. 7 and 8, the cells according to Exampled 6 and 7 had similar or lower power density and current density than the one of Comparative Example 3 under relative humidity of 65%, but excellent power density and current density under relative humidity of 45%. The unit cell of Example 8 had excellent results under both 65% and 45% relative humidity.

Accordingly, based on the results of Table 3 and FIGS. 6 to 8, the unit cells according to Examples 6 to 8 had excellent power density and current density under low relative humidity of 45%, which shows the unit cells can be operated under a non-humidifying condition or low humidifying condition.

Cell Performance Measurement

The unit cells according to Comparative Examples 6 to 8 were respectively operated with 0.6V and 0.5V and measured regarding current density and power density under relative humidity, humidifier temperature, and cell temperature provided in Table 2. The results are provided in the following Table 4. In addition, the results of Comparative Example 3 are also provided for comparison in Table 4.

TABLE 4

| | | 0.6 V | | 0.5 V | |
|---|---|---|---|---|---|
| | | Current | Power | Current | Power |
| | | density | density | density | density |
| | RH (%) | (mA/cm²) | (W/cm²) | (mA/cm²) | (W/cm²) |
| Comparative | RH100 | 0.68 | 0.41 | 1.14 | 0.57 |
| Example 3 | RH65 | 0.53 | 0.32 | 1.01 | 0.51 |
| | RH45 | 0.25 | 0.15 | 0.57 | 0.29 |
| Comparative | RH100 | 0.49 | 0.49 | 0.81 | 0.40 |
| Example 6 | RH65 | 0.344 | 0.344 | 0.67 | 0.33 |
| | RH45 | 0 | 0 | 0.028 | 0.013 |
| Comparative | RH100 | 0.70 | 0.70 | 1.12 | 0.56 |
| Example 7 | RH65 | 0.056 | 0.056 | 0.618 | 0.31 |
| | RH45 | 0 | 0 | 0.05 | 0.025 |
| Comparative | RH100 | 0.152 | 0.152 | 0.234 | 0.12 |
| Example 8 | RH65 | 0.162 | 0.162 | 0.244 | 0.12 |
| | RH45 | 0.104 | 0.104 | 0.164 | 0.082 |

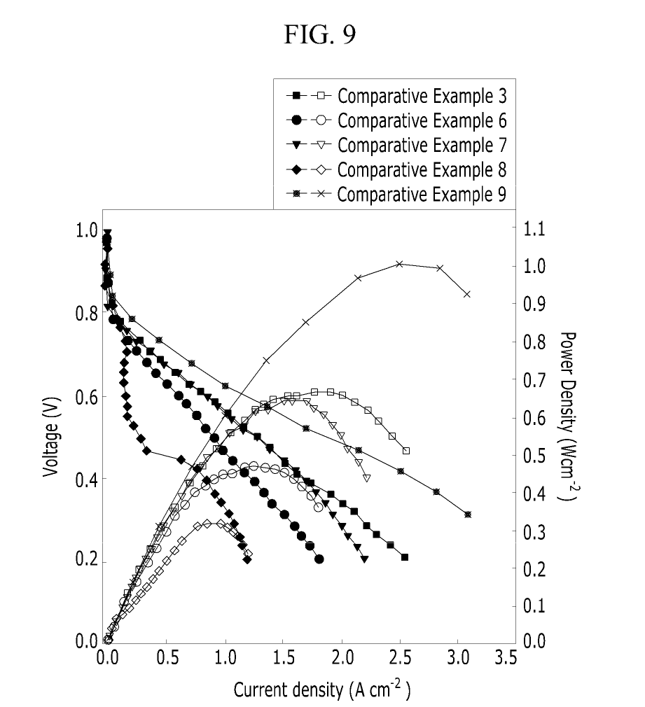

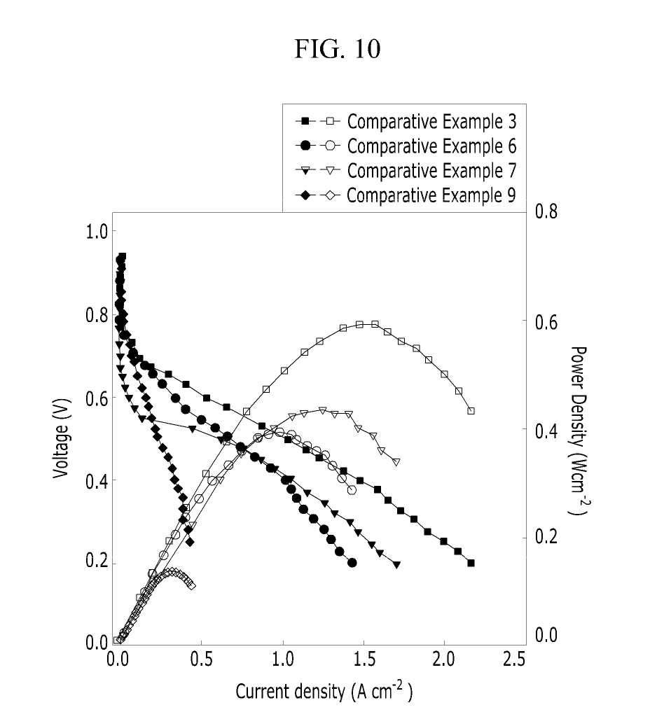

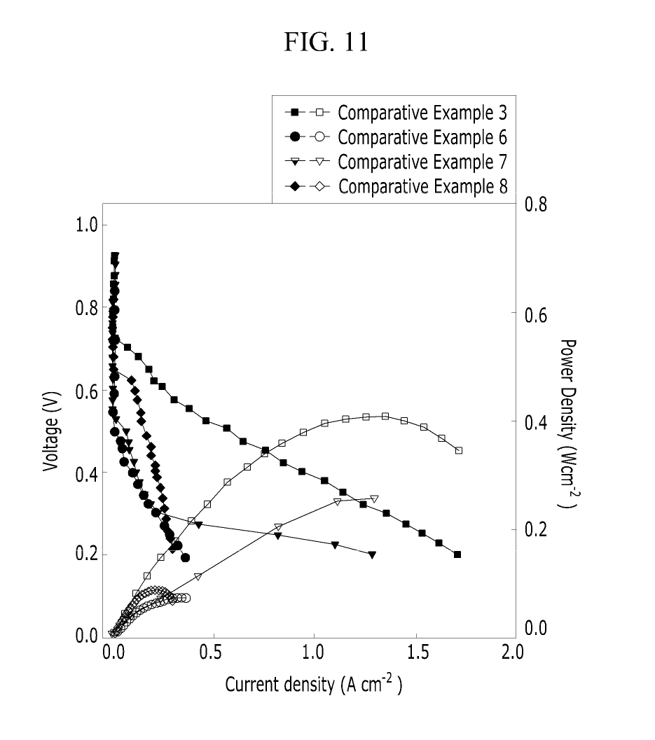

In addition, the results of Comparative Examples 6 to 9 and Comparative Examples 3 under relative humidity of 100% are provided in FIG. 9. Furthermore, the results of Comparative Examples 6 to 8 and 3 under relative humidity of 65% are provided in FIG. 10, and FIG. 11 provides the results thereof under relative humidity of 45%. Based on the results provided in FIG. 9 and Table 5, the unit cells of Comparative Examples 6 to 8 had excellent power density and current density regardless of relative humidity compared with the unit cell of Comparative Example 3. However, these results were degraded compared with power density and current density of the unit cells according to Examples 6 to 8 as shown in Table 3, and were also degraded compared with the unit cell including a Nafion polymer electrolyte membrane according to Comparative Example 9.

In addition, as shown in FIG. 10 and Table 5, the unit cell of Comparative Example 7 had similar or somewhat better results compared with the unit cell of Comparative Example 3 under relative humidity of 100%, but the unit cell had very deteriorated current density and power density under lower relative humidity of 65%, and did not work at all at 0.6V under low relative humidity of 45%.

As shown in FIG. 9 and Table 5, the unit cell of Comparative Example 6 had more deteriorated current density and power density than the one of Comparative Example 3 under all relative humidity conditions, and particularly, did not work at all at 0.6V under low relative humidity of 45%.

Accordingly, based on the results of Table 5 and FIGS. 9 to 11, since the unit cells according to Comparative Examples 6 to 8 had very deteriorated power density and current density compared with the ones according to Examples 6 to 8, the cells had deteriorated properties when a polymer electrolyte membrane was hydrophilic-treated and did not work at all under a non-humidifying or low humidifying condition.

### Comparative Example 10

A 51 μm-thick Nafion polymer (NR212, DuPont Co. (USA)) was placed on a sample stage facing toward a plasma generator with the other side toward the bottom of the sample stage in a plasma chamber.

Next, the 51 μm-thick Nafion polymer was plasma-treated by blowing in helium gas at a speed of 25 L/min and C₄F₈ gas at a speed of 15 ml/min, preparing an electrolyte membrane with one hydrophobic surface.

### Comparative Example 11

A polymer electrolyte membrane with both hydrophobic surfaces was fabricated by doing the same surface treatment on the other side (opposing the surface-treated side) of the polymer electrolyte membrane with one side hydrophobic surface treated as Comparative Example 10. The hydrophobic surface treatment was respectively performed to be 0.2 nm deep from the outermost surface.

### Comparative Example 12

A cathode with a cathode catalyst layer was fabricated by screen-printing a catalyst composition including 0.3 g of a Pt/C catalyst (Pt supported in carbon, 20 wt % of Pt and 80 wt % of carbon) and 0.495 g of a Nafion binder (a concentration of 5 wt % Nafion/H₂O/isopropanol) on a carbon paper electrode substrate including a microporous layer, 35BC, made by SGL Group.

On the other hand, an anode with an anode catalyst layer was fabricated by screen-printing a catalyst composition including 0.3 g of a Pt/C catalyst (Pt supported in carbon, 20 wt % of Pt and 80 wt % of carbon) and 0.495 g of a Nafion binder (a concentration of 5 wt % Nafion/H₂O/isopropanol) on a carbon paper electrode substrate including a microporous layer, 35BC, made by SGL Group.

The anode and the cathode were finally loaded with platinum in an amount of 0.3 mg/cm², respectively.

Then, a membrane-electrode assembly was fabricated by disposing the polymer electrolyte membrane according to Comparative Example 10 between the cathode and the anode and then, used to fabricate a unit cell in a common method. Herein, the hydrophobic surface of the polymer electrolyte membrane contacts the anode catalyst layer of the anode.

### Comparative Example 13

A unit cell was fabricated according to the same method as Comparative Example 12, except for disposing the cathode catalyst layer of the cathode to contact the hydrophobic surface of the polymer electrolyte membrane.

### Comparative Example 14

A unit cell was fabricated according to the same method as Comparative Example 12, except for using the polymer electrolyte membrane with both hydrophobic surfaces according to Comparative Example 11.

### Comparative Example 15

A unit cell was fabricated according to the same method as Comparative Example 12, except for using a 51 μm-thick polymer membrane (NR212, DuPont Co. (USA)) as an electrolyte membrane.

Surface Contact Angle Measurement

The polymer electrolyte membrane of Comparative Example 10 was measured regarding surface contact angle against distilled water, and the angle was 100.55°, which shows the polymer electrolyte membrane is hydrophobic.

Cell Performance Measurement

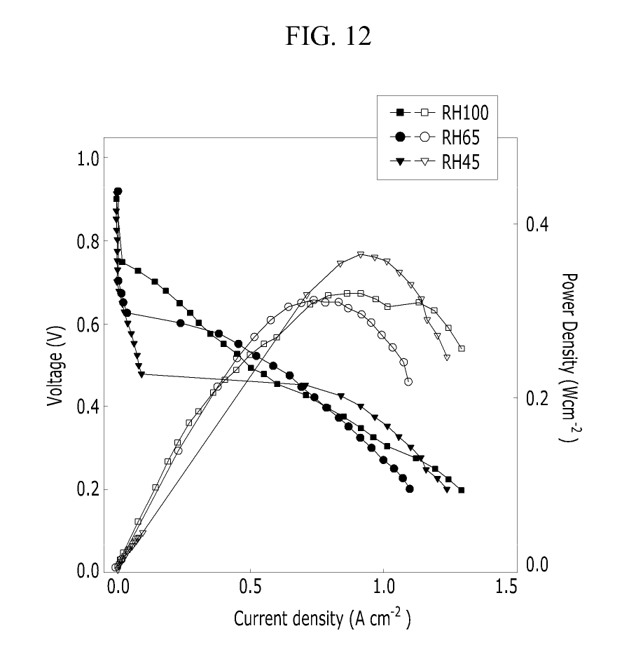

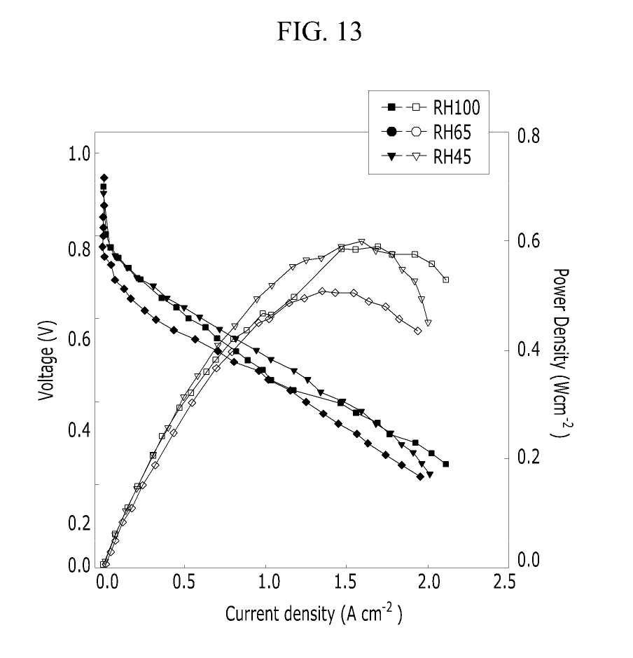

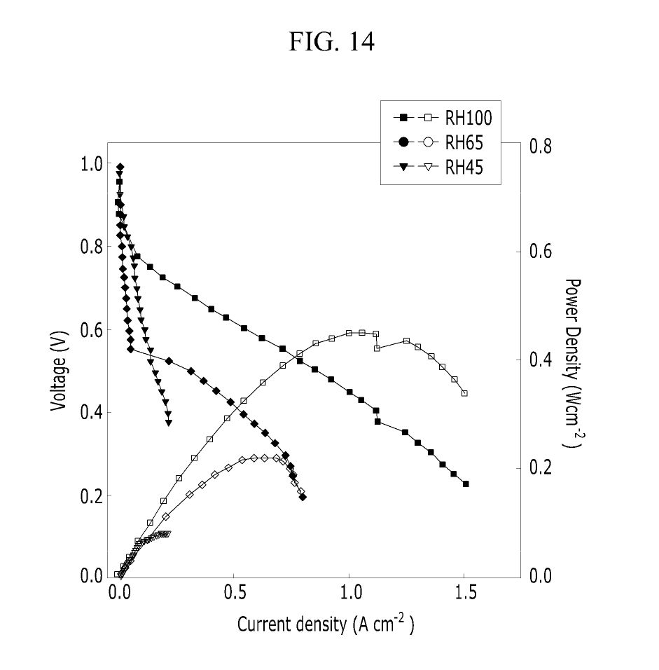

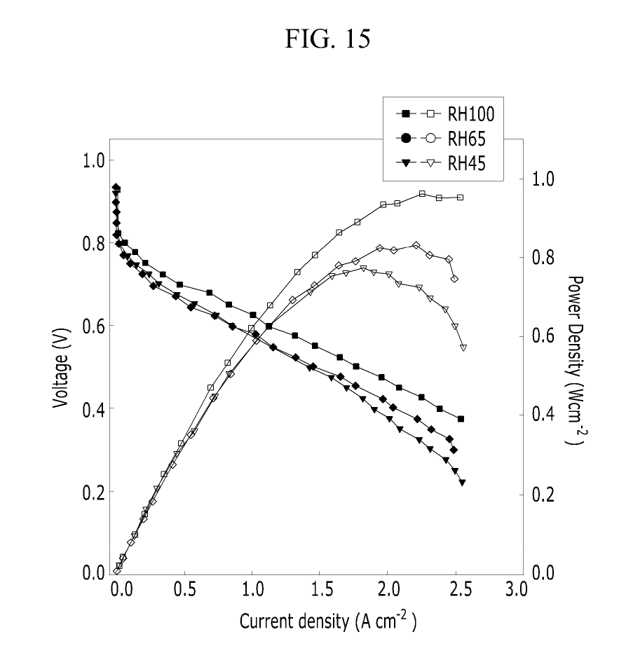

The unit cells according to Comparative Examples 12 to 15 were respectively measured regarding current density and power density at 70° C. under relative humidity of 100%, 65%, and 45%, and the results are provided in FIG. 12 (Comparative Example 12), FIG. 13 (Comparative Example 13), FIG. 14 (Comparative Example 14), and FIG. 15 (Comparative Example 15). In FIGS. 12 to 15, RHXX indicates that relative humidity is XX %.

As shown in FIGS. 12 to 15, Comparative Examples 12 to 14 using a hydrophobic Nafion polymer membrane through hydrophobic surface treatment regardless of relative humidity had very deteriorated power characteristics compared with Comparative Example 15 using a Nafion polymer membrane with no surface treatment.

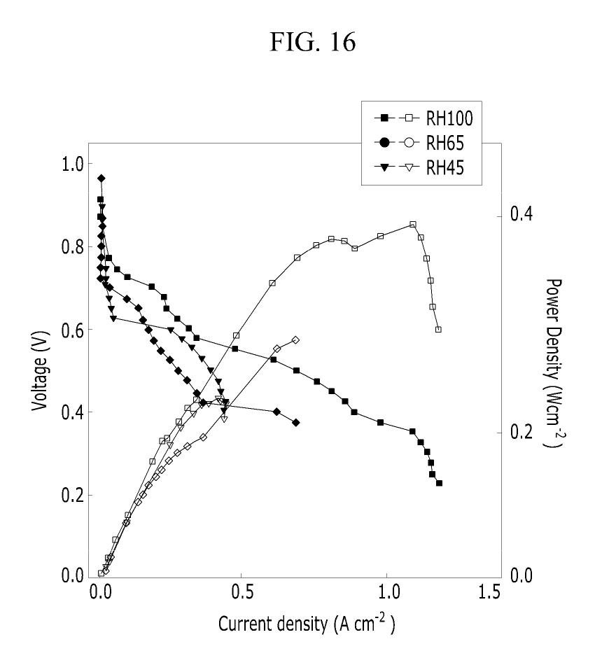

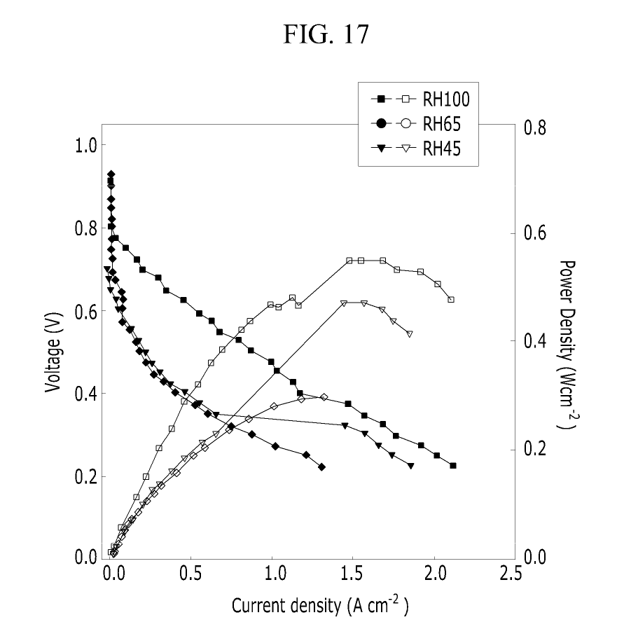

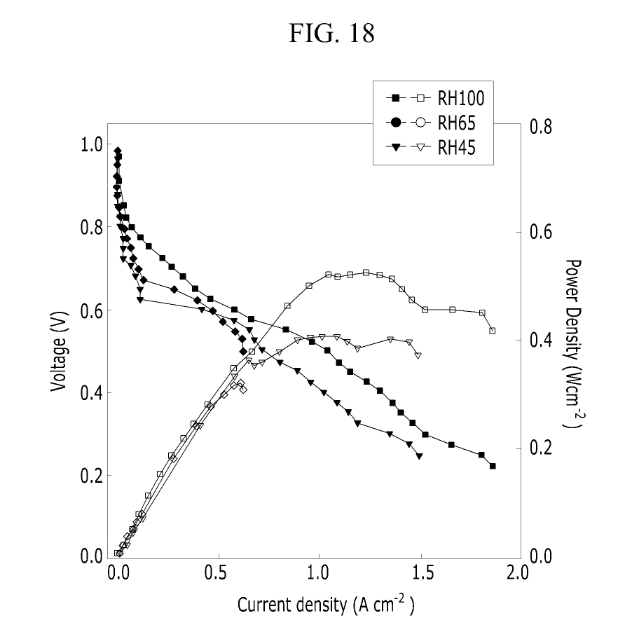

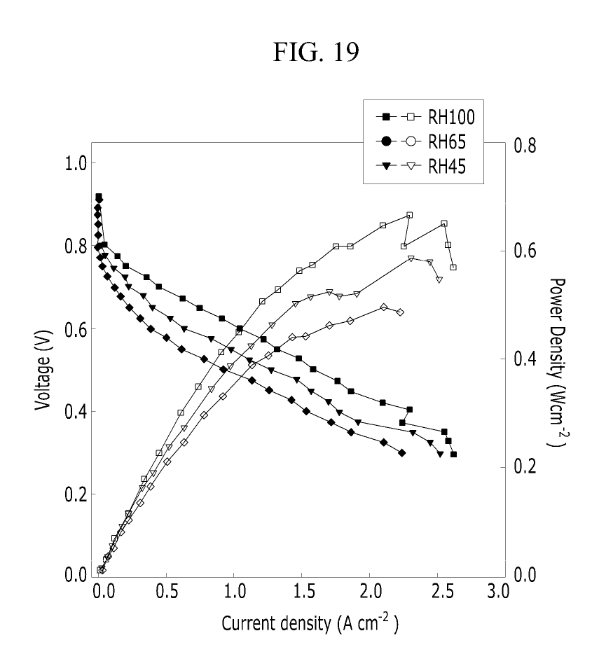

In addition, the unit cells according to Comparative Examples 12 to 15 were respectively measured regarding current density and power density at 80° C. under relative humidity of 100%, 65%, and 45%, and he results are provided in FIG. 16 (Comparative Example 12), FIG. 17 (Comparative Example 13), FIG. 18 (Comparative Example 14), and FIG. 19 (Comparative Example 15). Referring to FIGS. 16 to 19, RHXX indicates that relative humidity is XX %.

As shown in FIGS. 16 to 19, Comparative Examples 12 to 14 using a hydrophobic-treated Nafion polymer membrane had very deteriorated power characteristics compared with Comparative Example 15 using no surface-treated Nafion polymer membrane.

As a result, when a fluorine-based polymer electrolyte membrane rather than a hydrocarbon polymer electrolyte membrane is hydrophobic-treated, it is identified to degrade cell characteristics.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments are exemplary in every way but are not limiting to the present invention.

What is claimed is:

1. A polymer electrolyte membrane for a polymer electrolyte fuel cell comprising a hydrocarbon-based proton conductive polymer membrane and having a surface contact angle ranging from 80° to 180°.

2. The polymer electrolyte membrane of claim 1, which has a surface contact angle between 80° or more, and less than 120°.

3. The polymer electrolyte membrane of claim 1, wherein the hydrocarbon-based proton conductive polymer is a polymer having a proton conductive group, and the polymer is selected from the group consisting of a benzimidazole-based polymer, a benzoxazole-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer, a polyphenylquinoxaline-based polymer, a copolymer thereof, and a combination thereof.

4. A method of manufacturing the polymer electrolyte membrane for a polymer electrolyte fuel cell, comprising
hydrophobic surface-treating a hydrocarbon-based proton conductive polymer membrane using plasma.

5. The method of claim 4, wherein the hydrophobic treatment using plasma is performed by blowing in a first gas selected from argon gas, nitrogen gas, oxygen gas, helium gas, and a combination thereof, and a second gas selected from hydrocarbon gas, fluorocarbon gas, and a combination thereof.

6. The method of claim 5, wherein the hydrocarbon gas is CH₄ gas or C₂H₂ gas.

7. The method of claim 5, wherein the fluorocarbon gas is C₄F₈ gas, CF₄ gas, or a combination thereof.

8. The method of claim 4, wherein the plasma treatment is performed by blowing in a first gas selected from argon gas, nitrogen gas, oxygen gas, helium gas, and a combination thereof, and a second gas selected from the group consisting of CF₄ gas, C₄F₈ gas, and a combination thereof.

9. The method of claim 4, wherein the hydrocarbon-based proton conductive polymer is a polymer having a proton conductive group, and the polymer is selected from the group consisting of a benzimidazole-based polymer, a benzoxazole-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer, a polyphenylquinoxaline-based polymer, a copolymer thereof, and a combination thereof.

10. A polymer electrolyte fuel cell system comprising:
at least one electricity generating element including at least one membrane-electrode assembly including an anode and a cathode facing each other and a polymer electrolyte membrane disposed between the anode and the cathode and comprising a hydrocarbon-based polymer having a proton conductive group, and a separator, and generating electricity through oxidation of a fuel and reduction of an oxidizing agent;
a fuel supplier that supplies the electricity generating element with a fuel; and
an oxidant supplier that supplies the electricity generating element with an oxidant,
wherein the polymer electrolyte membrane has at least either surface of a first surface contacting the anode and a second surface contacting the cathode in a contact angle range of 80° to 180°.

11. The polymer electrolyte fuel cell system of claim 10, wherein at least either surface of the first and second surfaces has a contact angle between 80° or more and less than 120°.

12. The polymer electrolyte fuel cell system of claim 10, wherein the second surface has a contact angle ranging from 80° to 180°.

13. The polymer electrolyte fuel cell system of claim 10, wherein the first and second surfaces have a contact angle between more than 80° and less than 120°.
